(19) United States
(12) Patent Application Publication
(10) Pub. No.: US 2007/0146590 A1
(43) Pub. Date: Jun. 28, 2007

(54) Systems for displaying images involving transflective liquid crystal displays

(75) Inventors: Wei-Chih Chang, Jhubei City (TW); Li-Sen Chuang, Husi Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Toppoly Optoelectronics Corp.

(21) Appl. No.: 11/319,292

(22) Filed: Dec. 28, 2005

(51) Int. Cl. G02F 1/1335

(52) U.S. Cl. 349/114

(57) ABSTRACT

Systems for displaying images are provided. A representative system comprises a transflective liquid crystal display panel. The display panel comprises a liquid crystal display element and a retro-reflector disposed at the bottom of the liquid crystal display element such that an incident ray of light incident upon the retro-reflector is internally reflected twice such that the ray is redirected as a reflected ray that travels substantially parallel to the incident ray yet in an opposing direction.

### BACKGROUND

The invention relates to liquid crystal displays.

Typically, liquid crystal displays (LCDS) are divided into three categories: transmissive, reflective, and transflective. Transmissive LCDs are less effective light converters that merely transmit about 3% to 8% of light from the backlight. Therefore, transmissive LCDs require a backlight device having high brightness, leading to high power consumption. Reflective LCDs use ambient light for imaging, thus reducing power consumption. Reflective LCDs, however, can be used during the day or in environments where external light exists, but not at night or under poor lighting conditions.

FIG. 1 is a cross section of a conventional reflective LCD. The reflective LCD comprises a first substrate 10 and second substrate 20 opposing each other, and a liquid crystal layer 30 interposed between the first and second substrates 10 and 20. An upper polarizer 50 is disposed on the outer surface of the second substrate 20. A lower polarizer 40 is disposed on the bottom of the first substrate 10. A reflector 60 is disposed on the bottom of the lower polarizer 40. The first substrate 10, liquid crystal layer 30 and the second substrate form a liquid crystal panel.

The reflective LCD also comprises a plurality of pixels 35. In this regard, incident light L_{I} enters the reflective LCD and passes through a pixel 35. The light is then reflected by reflector 60 and passes through another pixel. When an observer views incident light passing through a pixel and reflected light passing through another pixel simultaneously, overlapping images can occur. However, overlapping images can reduce display quality.

### SUMMARY

Systems for displaying images are provided. An embodiment of such a system comprises a transflective liquid crystal display panel. The display panel comprises a liquid crystal display element and a retro-reflector disposed at the bottom of the liquid crystal display element such that an incident ray of light incident upon the retro-reflector is internally reflected twice such that the ray is redirected as a reflected ray that travels substantially parallel to the incident ray yet in an opposing direction.

Another embodiment of such a system comprises a transflective liquid crystal display panel. The display panel comprises: a first substrate having a plurality of pixels, each of the pixels comprising a reflective region and a transmissive region; a second substrate; a twisted nematic liquid crystal layer located between the first substrate and the second substrate; a first polarizer on the first substrate; a second polarizer between the second substrate and the retro-reflector; and a retro-reflector disposed on the second substrate with a plurality of retro-reflective elements and transmissive elements, each of the retro-reflective elements corresponding to one of the reflection regions and each of the transmissive elements corresponding to one of the transmissive regions.

### DESCRIPTION OF THE DRAWINGS

The invention will become more fully understood from the detailed description given hereinbelow and the accompanying drawings, given by way of illustration only and thus not intended to be limitative of the invention.

FIG. 1 is a cross section of a conventional reflective liquid crystal display;

FIG. 2 is a cross-section of a transflective liquid crystal display panel according to an embodiment of the invention;

FIGS. 3A-3C are plan views of embodiments of retro-reflectors with an array of retro-reflective elements;

FIG. 4 is a schematic view of embodiment of retro-reflective element according to an embodiment of the invention;

FIGS. 5A-5C are cross sections of embodiments of transflective liquid crystal display panels;

FIG. 6 is a schematic diagram of a display device comprising a transflective liquid crystal display panel in accordance with an embodiment of the invention; and

FIG. 7 is a schematic diagram of an electronic device incorporating a display device that comprises a transflective liquid crystal display panel in accordance with an embodiment of the invention.

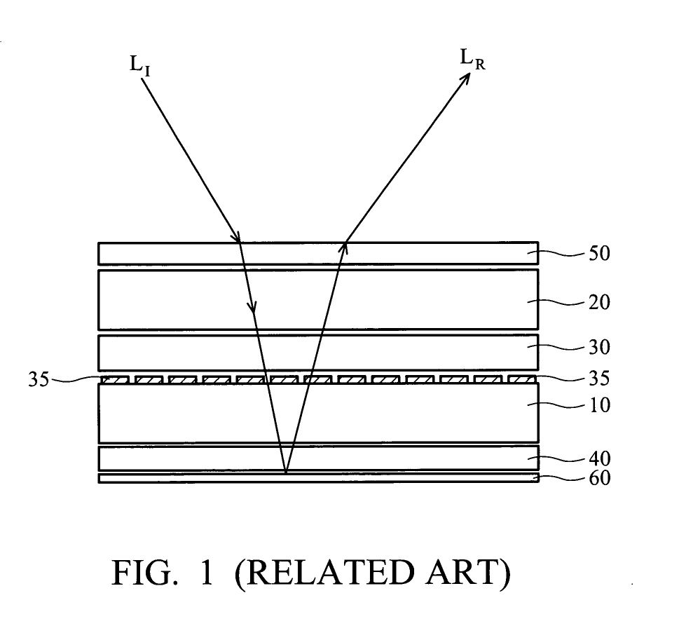

### DETAILED DESCRIPTION

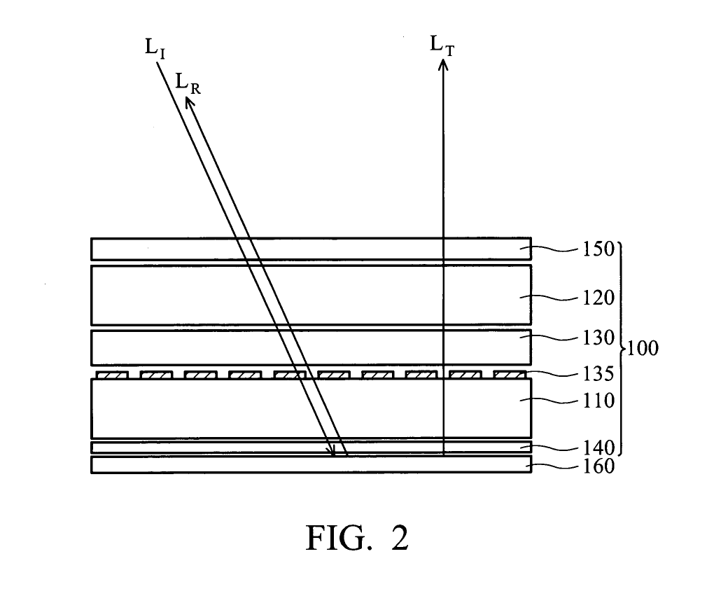

As will be described with reference to the drawings, systems for displaying images are provided that can potentially prevent image overlap problems by using retro-reflectors. In this regard, FIG. 2 is a cross-section of a transflective liquid crystal display panel according to an embodiment of the invention. The transflective liquid crystal display device of this embodiment comprises a retro-reflective plate. A ray of incident light directed toward the retro-reflective plate reflects twice, with the reflected ray and the incident ray tracing substantially parallel to each other, thereby reducing image overlapping problems.

Referring to FIG. 2, a transflective liquid crystal display device comprises a liquid crystal display element 100 in which a liquid crystal layer 130 is located between a first substrate 120 and a second substrate 110. In this embodiment, liquid crystal layer 130 comprises a twisted nematic type liquid crystal; however, other types can be used in other embodiments. A plurality of pixel areas 135 are formed along an inner surface of the second substrate 110. Each pixel area 135 comprises a reflective region and a transmissive region. A first polarizer 150 is disposed on the first substrate 120. A second polarizer 140 is disposed on the outer surface of the second substrate 110.

The liquid crystal display device also comprises a retro-reflector 160 disposed at the bottom of the liquid crystal display element 100. The retro-reflector incorporates a plurality of retro-reflective elements and transmission elements. Notably, most reflectors reflect light twice, where the angle of incidence of light L_{I} equals the angle of reflectance of light L_{R}. A retro-reflector is different, in that the reflected light returns in a direction parallel to the direction of the incident light. Specifically, the incident light is reflected 180 degrees by the retro-reflector.

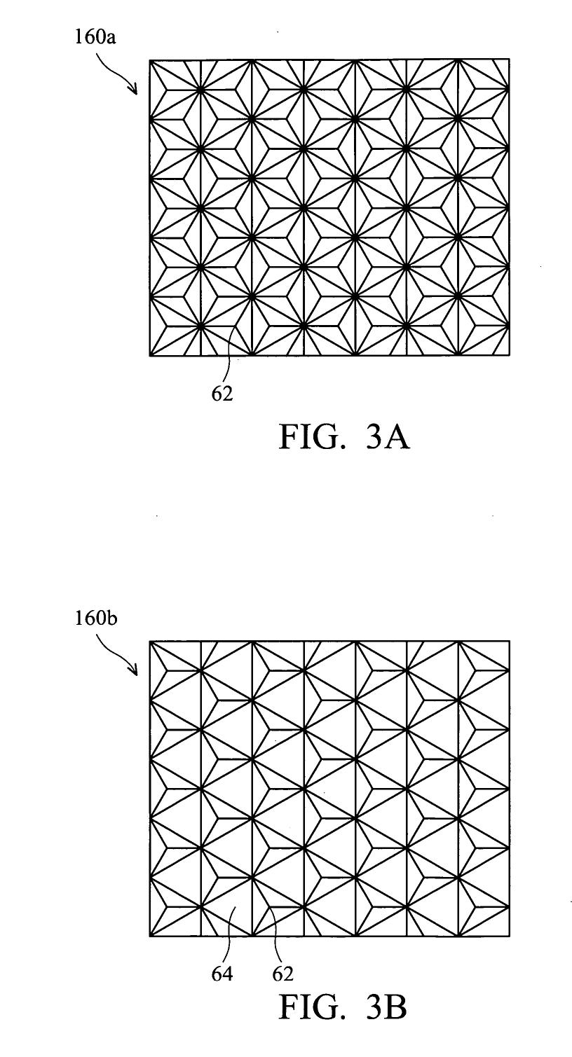

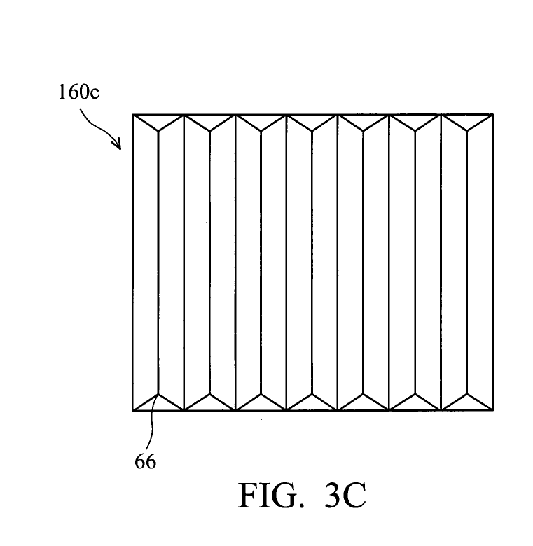

FIG. 3A is a plan view of a retro-reflector with an array of retro-reflective elements according to an embodiment of the invention. In particular, retro-reflector plate 160a comprises an array of retro-reflective elements 62, which are shaped as trigonal pyramids in this embodiment. Referring to FIG. 3B, a retro-reflector plate 160b comprises a plurality of retro-reflective elements 62 and transmission elements 64. Each retro-reflective element 62 corresponds to the reflection region of the pixel area 135 of FIG. 2 and each transmissive element 64 corresponds to the transmissive region of the pixel area 135 of FIG. 2. The transmissive element 64 is substantially planar that can transmit incident light L_{T} from a backlight system (not shown).

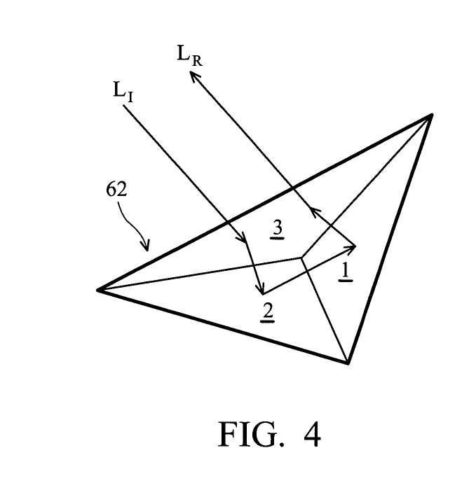

FIG. 4 is a schematic view of a retro-reflective element according to an embodiment of the invention. The retro-reflective element 62 of this embodiment comprises three faces, any two of the three faces being perpendicular to each other. Alternatively, the retro-reflective element 62 may comprise three faces, any two of the three faces defining an included angle in a range of 90±10 degrees, preferably 90±5 degrees. A ray of incident light L_{I} incident to the retro-reflective element 62 undergoes total internal reflection as shown in FIG. 4. Thus, the ray of light 1 is retro-reflected from the element 62 in a direction L_{R} that is opposite to the direction of the incident light. The retro-reflective element may comprise a linear prism or a wavelike prism, for example.

Alternatively, a retro-reflector plate may comprise a plurality of linear prisms. Referring to FIG. 3C, an example of such a retro-reflector plate 160 incorporates linear prisms. As shown in FIG. 3C, the linear prisms 66 are parallel to each other. A planar transmissive element (not shown) may optionally be interposed between adjacent linear prisms 66. Notably, a retro-reflective element 62 can be a projection or a recess. Alternatively, a retro-reflective element 66 can be a linear prism ridge or parallel groove.

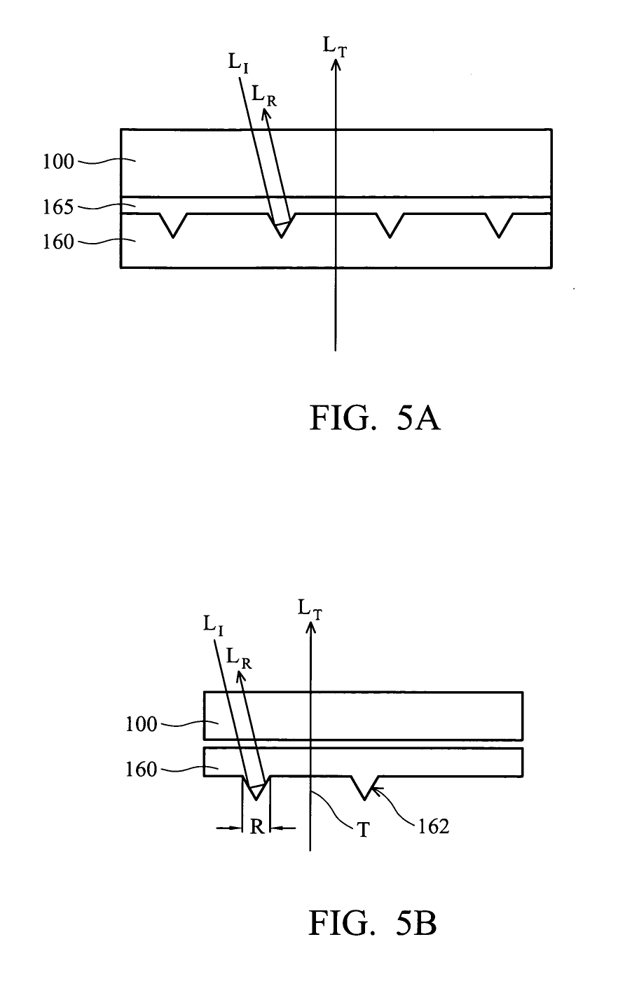

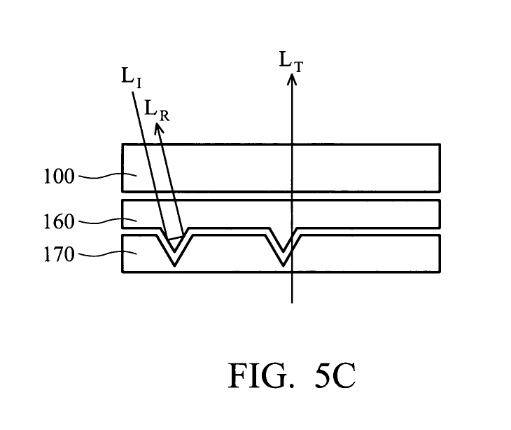

FIG. 5A is a cross section of a transflective liquid crystal display according to an embodiment of the invention. A retro-reflector 160 is disposed at the bottom of a liquid crystal display element 100. The retro-reflector comprises a plurality of retro-reflective elements, such as reverse trigonal pyramids or trigonal pyramid recesses. A metal layer, such as Al or Ag, for example, can be optionally formed on the surface of the retro-reflective elements. An adhesive layer 165 is arranged along an interface between the liquid crystal display element 100 and the retro-reflector 160. The adhesive layer 165 may comprise an epoxy, an acrylic resin, or a benzocyclobutene (BCB), for example.

Referring to FIG. 5B, a retro-reflector 160 may alternatively be disposed at the bottom of a liquid crystal display element 100, with the retro-reflective element 162 opposing the liquid crystal display element 100. The retro-reflective elements comprise trigonal pyramids or trigonal pyramid projections. An adhesive layer (not shown) is arranged along an interface between the liquid crystal display element 100 and the retro-reflector 160. The adhesive layer may comprise an epoxy, an acrylic resin, or a benzocyclobutene (BCB).

FIG. 5C is a cross section of a transflective liquid crystal display according to another embodiment of the invention. A compensation structure 170 is disposed under the retro-reflector 160, wherein shapes of the compensation structure 170 and the retro-reflector 160 are complementary.

An adhesive layer is interposed between the compensate structure 170 and the retro-reflector 160. The adhesive layer may comprise an epoxy, an acrylic resin, or a benzocyclobutene (BCB). The LCD configuration shown in FIG. 5C can reduce transmission light scattering and improve image quality of the transmissive region.

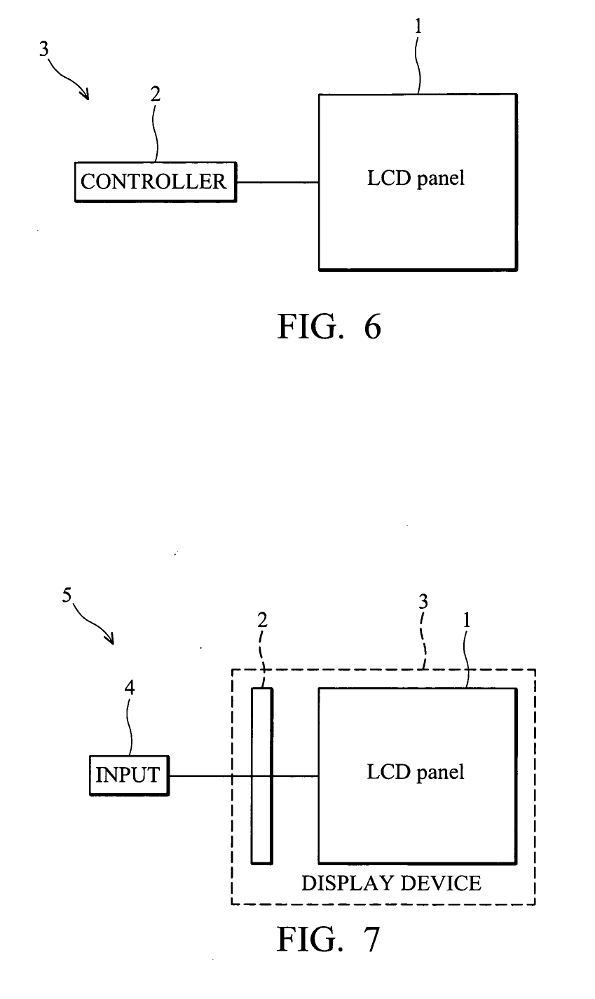

FIG. 6 is a schematic diagram of a display device 3 comprising an embodiment of a transflective liquid crystal display panel. The transflective liquid crystal display panel 1 is coupled to a controller 2, forming a display device 3 as shown in FIG. 6. The controller 3 comprises source and a gate driving circuits (not shown) to control the transflective liquid crystal display panel 1 to render image in accordance with an input.

FIG. 7 is a schematic diagram of an electronic device 5, incorporating a display device comprising an embodiment of a transflective liquid crystal display panel. An input device 4 is coupled to the controller 2 of the display device 3. Input device 4 includes a processor or the like to input data to the controller 2 to render an image. The electronic device 5 may be a portable device such as a PDA, notebook computer, tablet computer, cellular phone, or a desktop computer, for example.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for displaying images comprising:
a transflective liquid crystal display panel, comprising:
a liquid crystal display element; and
a retro-reflector disposed at the bottom of the liquid crystal display element;
wherein an incident ray of light incident upon the retro-reflector is internally reflected twice such that the ray is redirected as a reflected ray that travels substantially parallel to the incident ray yet in an opposing direction.

2. The system as claimed in claim 1, wherein the retro-reflector comprises a retro-reflector element operative to reflect incident light and a transmissive element operative to transmit incident light.

3. The system as claimed in claim 1, wherein the retro-reflective element comprises a trigonal pyramid shape.

4. The system as claimed in claim 2, wherein the retro-reflective element comprises three faces, with any two of the three faces being perpendicular to each other.

5. The system as claimed in claim 2, wherein the retro-reflective element comprises three faces, with any two of the three faces defining an included angle in a range of 90±10 degrees.

6. The system as claimed in claim 1, wherein the liquid crystal layer comprises twisted nematic mode liquid crystal material.

7. The system as claimed in claim 1, further comprising a first polarizer adjacent to the liquid crystal display element; and a second polarizer located between the liquid crystal display element and the retro-reflector.

8. The system as claimed in claim 1, further comprising a compensation structure disposed under the retro-reflector.

9. A system for displaying image comprising:
a transflective liquid crystal display panel, comprising:
a first substrate having a plurality of pixels, each of the pixels comprising a reflective region and a transmissive region;
a second substrate;
a twisted nematic liquid crystal layer located between the first substrate and the second substrate;
a first polarizer on the first substrate;
a second polarizer between the second substrate and the retro-reflector; and
a retro-reflector disposed on the second substrate with a plurality of retro-reflective elements and transmissive elements, each of the retro-reflective elements corresponding to one of the reflection regions and each of the transmissive elements corresponding to one of the transmissive regions.

10. The system as claimed in claim 9, wherein at least one of the retro-reflective elements comprises a trigonal pyramid shape.

11. The system as claimed in claim 9, wherein the retro-reflective element comprises three faces, with any two of the three faces defining an included angle in a range of 90±10 degrees.

12. The system as claimed in claim 9, wherein the transmissive elements are substantially planar.

13. The system as claimed in claim 9, wherein the system comprises a transflective liquid crystal display device, comprising
the transflective liquid crystal display panel; and
the system further comprises a controller coupled to the transflective liquid crystal display panel to control the panel to render an image in accordance with an input.

14. The system as claimed in claim 13, wherein the system comprises an electronic device comprising
the transflective liquid crystal display device.

15. The system as claimed in claim 14, wherein the electronic device is a laptop computer.

16. The system as claimed in claim 9, wherein the system comprises
the transflective liquid crystal display panel; and
the system further comprises
means for controlling the panel.
